(19) United States
(12) Patent Application Publication
(10) Pub. No.: US 2026/0003782 A1
(43) Pub. Date: Jan. 1, 2026

(54) BAD BLOCK REPLACEMENT BY A MEMORY SYSTEM

(71) Applicant: Micron Technology, Inc., Boise, ID (US)

(72) Inventor: Jianye Cao, Shenzhen (CN)

(21) Appl. No.: 19/224,446

(22) Filed: May 30, 2025

Related U.S. Application Data
(60) Provisional application No. 63/666,004, filed on Jun. 28, 2024.

(51) Int. Cl. G06F 12/02

(52) U.S. Cl. CPC G06F 12/0246; G06F 2212/7202

(57) ABSTRACT

Methods, systems, and devices for bad block replacement by a memory system are described. For example, a memory system may replace bad blocks with available user blocks if a quantity of replacement blocks satisfies a threshold value. In some examples, a memory system that includes the memory device may notify an end-user that the quantity of replacement blocks satisfies the threshold value. In response, the memory system may receive an indication from the end-user to use the available user blocks (e.g., blocks designated for storing user data) to replace the bad blocks.

### CROSS REFERENCE

The present Application for Patent claims priority to U.S. Patent Application No. 63/666,004 by Cao, entitled “BAD BLOCK REPLACEMENT BY A MEMORY SYSTEM,” filed Jun. 28, 2024, which is assigned to the assignee hereof, and which is expressly incorporated by reference in its entirety herein.

### TECHNICAL FIELD

The following relates to one or more systems for memory, including bad block replacement by a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports bad block replacement by a memory system in accordance with examples as disclosed herein.

FIG. 2 shows an example of a block diagram that supports bad block replacement by a memory system in accordance with examples as disclosed herein.

FIG. 3 shows an example of a process that supports bad block replacement by a memory system in accordance with examples as disclosed herein.

FIG. 4 shows a block diagram of a memory system that supports bad block replacement by a memory system in accordance with examples as disclosed herein.

FIG. 5 shows a flowchart illustrating a method or methods that support bad block replacement by a memory system in accordance with examples as disclosed herein.

### DETAILED DESCRIPTION

In some memory systems, one or more blocks may experience an uncorrectable error or otherwise become defective (e.g., over a duration, over the memory system's life-cycle). Such blocks may be referred to as bad blocks. For example, one or more blocks may become bad based on repeated access operations, which may degrade the block and result in the block being unable to reliably store data. Some memory systems may include a quantity of replacement blocks (e.g., reserve blocks) to replace the bad blocks. However, the quantity of replacement blocks may be fixed or finite (e.g., a percentage of the total blocks of the memory system), such that if the memory system uses the replacement blocks, the memory system may be unable to replace additional bad blocks. In some examples, the memory system may enter a write-protect mode if a quantity of available replacement blocks becomes relatively low (e.g., less below a threshold), which may prevent the memory system from operating efficiently or at all (e.g., the memory system may not boot-up correctly or at all in response to the write-protect mode). Thus, it may be desirable to enable the memory system to replace bad blocks and refrain from entering a write-protect mode based on the quantity of available replacement blocks is relatively low.

The techniques described herein may enable a memory system to replace bad blocks and refrain from entering a write-protect mode based on a quantity of available replacement blocks is relatively low. For example, if a quantity of replacement blocks satisfies a threshold (e.g., is relatively low), the memory system may notify an end-user. The memory system may be referred to herein as a storage system. The memory system may receive an indication from the end-user to use one or more available user blocks (e.g., blocks designated for storing user data) to replace the bad blocks. In some examples, replacing the bad blocks with the available user blocks may enable the memory system to operate and export user data, and thus not enter the write-protect mode. For example, the memory system may export (e.g., transfer) the user data to an external memory device (e.g., external to the memory system, such as an external solid-state drive (SSD)). Exporting the user data may allow for the data to be stored and imported back to the memory system after rebooting. Rebooting may enable the memory system to re-provision and re-download firmware in accordance with the freed up user blocks. Thus, the memory system may preserve user data (e.g., via exporting the data) and maintain its operational status (e.g., refrain from entering write-protect mode) in response to replacing bad blocks with the one or more available user blocks, which may improve its overall performance and usable life.

In addition to applicability in memory systems as described herein, techniques for bad block replacement by a memory system may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by enabling a memory system to replace bad blocks with available user blocks, which may extend the life-cycle of the memory system, and enable some systems to boot-up and recover user-data (e.g., user equipment without this feature may not boot-up), among other benefits.

Features of the disclosure are illustrated and described in the context of systems, devices, and circuits. Features of the disclosure are further illustrated and described in the context of a block diagram, a process, and flowcharts.

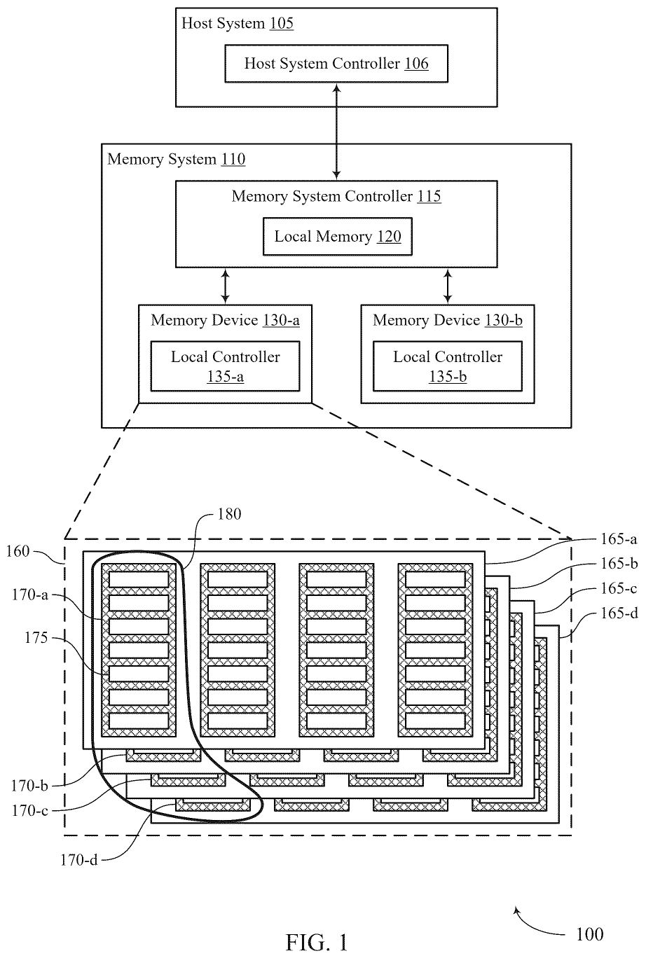

FIG. 1 shows an example of a system 100 that supports bad block replacement by a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some memory systems 110, one or more blocks 170 may experience an uncorrectable error or otherwise become defective over the memory system's life-cycle. Such blocks 170 may be referred to as bad blocks. For example, one or more blocks 170 may become bad blocks in response to repeated access operations, which may degrade the block 170 and result in the block 170 being unable to reliably store data. Some memory systems 110 may include a quantity of replacement blocks (e.g., reserve blocks) to replace the bad blocks. However, the quantity of replacement blocks may be fixed (e.g., a percentage of the total blocks of the memory system 110), such that if the memory system 110 uses the replacement blocks, the memory system 110 may be unable to replace additional bad blocks. In some examples, the memory system 110 may enter a write-protect mode in response to a quantity of available replacement blocks being relatively low (e.g., falling below a threshold), which may prevent the memory system 110 from operating (e.g., the memory system 110 may not boot-up correctly or at all in response to the write-protect mode). Thus, it may be desirable to enable the memory system 110 to replace bad blocks and refrain from entering a write-protect mode based on the quantity of available replacement blocks is relatively low.

The techniques described herein may enable a memory system 110 to replace bad blocks and refrain from entering a write-protect mode based on a quantity of available replacement blocks is relatively low. For example, if a quantity of replacement blocks satisfies a threshold (e.g., is relatively low), the memory system 110 may notify an end-user (e.g., via the host system 105). The memory system 110 may be referred to herein as a storage system. The memory system 110 may receive an indication from the end-user to use one or more available user blocks (e.g., blocks designated for storing user data) to replace the bad blocks. In some examples, replacing the bad blocks with the available user blocks may enable the memory system 110 to operate and export user data, and not enter the write-protect mode. For example, the memory system 110 may export (e.g., transfer) the user data to an external memory device 130 (e.g., external to the memory system 110, such an external SSD). Exporting the user data may allow for the data to be stored and imported back to the memory system 110 after rebooting. Rebooting may enable the memory system 110 to re-provision and re-download firmware (e.g., software) in accordance with the freed up user blocks. Thus, the memory system may preserve user data (e.g., via exporting the data) and maintain its operational status (e.g., refrain from entering the write-protect mode) in response to replacing bad blocks with the one or more available user blocks, which may improve its overall performance and usable life.

The system 100 may include any quantity of non-transitory computer readable media that supports bad block replacement by a memory system 110. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

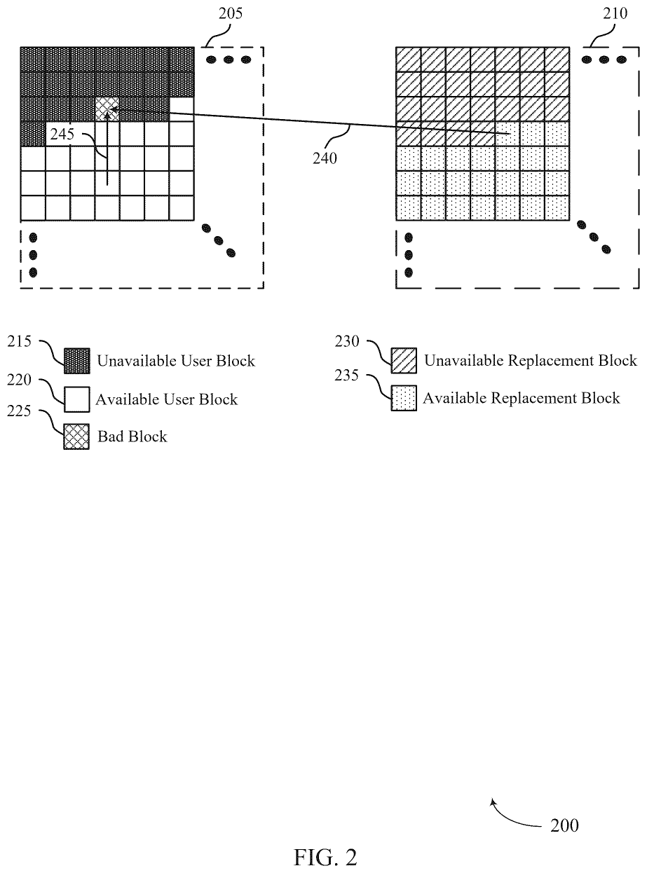

FIG. 2 shows an example of a block diagram 200 that supports bad block replacement by a memory system in accordance with examples as disclosed herein. The memory system, which may be referred to herein as a storage system (e.g., a UFS or an SSD), may include one or more non-volatile memory cells (e.g., NAND memory cells). The block diagram 200 may include a user block pool 205 and a replacement block pool 210. In some examples, the block diagram 200 may represent a quantity of blocks in a first memory device (e.g., a first memory device 130). That is, the block diagram 200 may represent logical constructs of blocks, such as the blocks 170 described with reference to FIG. 1. For example, the user block pool 205 and the replacement block pool 210 may be logical representations of physical blocks in the first memory device.

The user block pool 205 may include multiple user blocks, such as unavailable user blocks 215 and available user blocks 220. An unavailable user block 215 may be a block that includes a threshold quantity of user data. For example, a block may be an unavailable user block 215 if the block stores user data in at least one page (e.g., a page 175) or in all pages of the block. An available user block 220 may be a block designated for user data, but does not currently store the threshold quantity of user data. For example, a block may be an available user block 220 if the block does not store user data in at least one page or in all pages of the block (e.g., a block 170 that includes a respective set of pages 175).

In some examples, a user block (e.g., an unavailable user block 215 or an available user block 220) may become a bad block 225 over time. A bad block 225 may be a block that includes one or more errors (e.g., a defective block) or otherwise becomes defective over time. For example, the bad block 225 may not reliably store data. In some examples, data stored in a bad block 225 may be prone to being lost or corrupted. A user block may become a bad block during the production of the first memory device (e.g., a bad block may result from a manufacturing defect). Additionally, or alternatively, a user block may become a bad block 225 during a life-cycle of the first memory device. For example, a user block may degrade over time in response to a quantity of access operations (e.g., program/erase cycles) performed on the block, based on experiencing relatively high or low temperatures (e.g., temperatures outside nominal conditions for prolonged durations), and the like. In some examples, the first memory device may detect a bad block 225 (e.g., via error detection and correction such as error correction code (ECC) circuitry, or via a controller such as a local memory controller 135 as described with reference to FIG. 1), and use a replacement block from the replacement block pool 210 to replace the bad block 225. For example, the first memory device may detect a bad block 225 before, after, or while performing one or more access operations (e.g., read, write, or erase operations).

The replacement block pool 210 may include multiple replacement blocks, such as unavailable replacement blocks 230 and available replacement blocks 235. In some examples, replacement blocks may be blocks designated by the first memory device for replacing bad blocks 225, and may not store user data prior to replacing a bad block 225 (e.g., replacement blocks may be referred to as reserve blocks or redundant blocks). An unavailable replacement block 230 may be a block that has replaced a bad block 225 in the user block pool 205 (e.g., the unavailable replacement block 230 may become an unavailable user block 215 or an available user block 220 based on replacing the bad block 225). An available replacement block 235 may be a replacement block that has not replaced a bad block 225.

In some examples, a quantity of replacement blocks in the replacement block pool 210 may be a fixed quantity (e.g., a set quantity, a static quantity), and a memory system controller (e.g., a controller of the first memory device) may track the quantity of replacement blocks using a counter. The quantity of replacement blocks may be a percentage of the total quantity of blocks included in the first memory device (e.g., the total amount of user blocks). In some examples, the memory system controller may decrement the counter in response to detecting a bad block 225 (e.g., the memory system controller may track a quantity of available replacement blocks 235). For example, the memory system controller may detect the bad block 225, decrement the counter, and use an available replacement block 235 to replace a bad block 225 in a first replacement operation 240 (e.g., replacing a bad block 225 with an available replacement block 235 decreases the quantity of available replacement blocks 235). Additionally, or alternatively, the memory system controller may increment the counter in response to detecting the bad block 225. In such examples, the memory system controller may count a quantity of replacement blocks used to replace the bad blocks 225 (e.g., the counter may be a quantity of unavailable replacement blocks 230). For example, the memory system controller may detect the bad block 225, increment the counter, and use an available replacement block 235 to replace the bad block 225 in the first replacement operation 240 (e.g., increasing the quantity of unavailable replacement blocks 230).

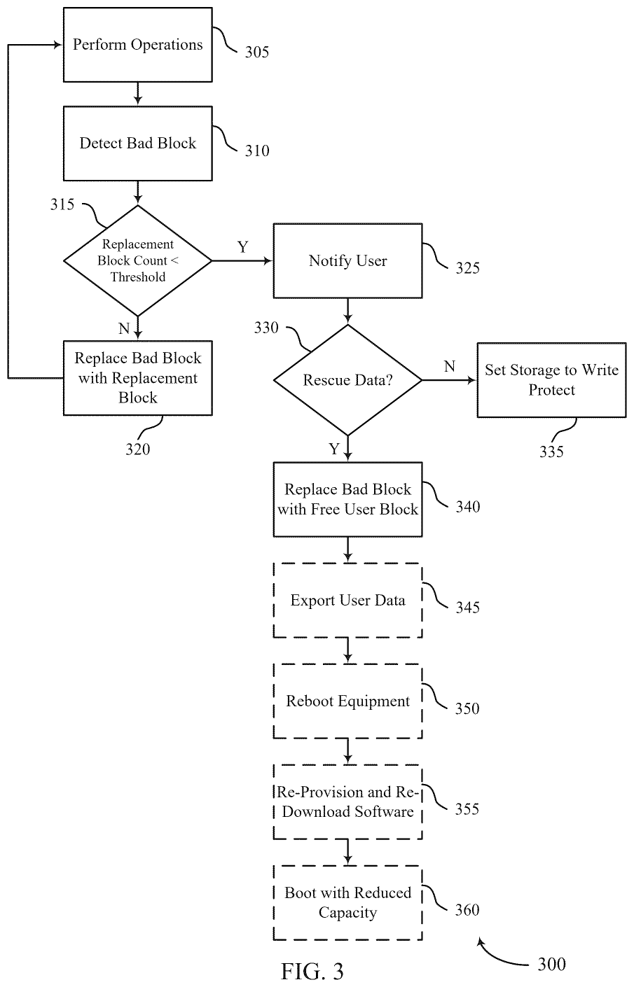

As discussed further with reference to FIG. 3, the memory system controller may compare the counter to a threshold value after each time the counter is updated (e.g., decremented or incremented). For example, if the memory system controller is decrementing the counter (e.g., counting the quantity of available replacement blocks 235), the threshold value may be zero. If the memory system controller is incrementing the counter (e.g., counting the quantity of unavailable replacement blocks 230), the threshold value may be the total quantity of replacement blocks. In memory systems that do not support replacing a bad block 225 with an available user block 220 as described herein, the first memory device may enter a write-protect mode if the counter satisfies the threshold value (e.g., the replacement block pool 210 does not include any available replacement blocks 235).

A write-protect mode may be a mode where the first memory device may not perform any access operations that can modify user data stored to the user blocks. For example, in a write-protect mode, the first memory device may support read commands to the user blocks, but may not allow write or erase commands to the user blocks. In some examples, the memory system that includes the first memory device may not operate in response to the first memory device entering the write-protect mode. For example, the memory system may write data to a block to initiate a boot-up sequence (e.g., to transition from a first power state to a second power state higher than the first power state). The write-protect mode may prevent the memory system from writing to a block to initiate the boot-up sequence, which may cause the user data in the user blocks to become inaccessible (e.g., an end-user may not access the data because the memory system may not boot-up). Thus, it may be desirable to enable the memory system to boot-up and preserve access to user data.

As described further with reference to FIG. 3, the memory system may transmit an indication that the quantity of available replacement blocks 235 satisfies the threshold value (e.g., is less than or equal to the threshold value). The end-user may indicate the memory system to replace a bad block 225 with an available user block 220 in a second replacement operation 245. In some examples, the second replacement operation 245 may reduce a capacity of user data of the first memory device, but may rescue (e.g., preserve) the user data by enabling the memory system to operate (e.g., not enter the write-protect mode). For example, using available user blocks 220 to replace bad blocks 225 reduces the quantity of available user blocks 220 for storing user data, but enables the memory system to operate and export the user data to a second memory device. In some examples, the memory system may track a quantity of available user blocks 220 used to replace bad blocks 225. For example, the memory system may transmit the quantity of available user blocks 220 to the end-user using the tracked quantity. Replacing the bad blocks 225 with available user blocks 220 if the quantity of available replacement blocks 235 satisfies the threshold value may enable the memory system to initiate the boot-up sequence (e.g., and thus, the end-user may access the data stored in the user blocks) without entering a write-protect mode.

In some examples, the first memory device may export (e.g., transfer) user data from one or more unavailable user blocks 215 to the second memory device (e.g., to user blocks in the second memory device). The second memory device may be external to the memory system and, thus, may be different than the first memory device. For example, the second memory device may be an SSD, a storage in a computer device connected to the memory system, or some other storage device external to the memory system. Exporting the user data may enable the end-user to protect the user data. For example, the first memory device may have a limited quantity of available user blocks 220 to use to replace bad blocks 225, and may not initiate the boot-up sequence if all the available user blocks 220 are used to replace bad blocks 225 (e.g., the first memory device may enter the write-protect mode if the bad blocks 225 cannot be replaced). Thus, enabling the memory system to replace bad blocks 225 with available user blocks 220 may enable the memory system to preserve user data (e.g., via exporting the data) and maintain its operational status (e.g., refrain from entering the write-protect mode) in response to replacing bad blocks with the one or more available user blocks, which may improve its overall performance and usable life.

FIG. 3 shows an example of a process 300 that supports bad block replacement by a memory system in accordance with examples as disclosed herein. The memory system, which may be referred to herein as a storage system, may include one or more non-volatile memory cells (e.g., NAND memory cells). The process 300 may be implemented by the aspects of the system 100 as described with reference to FIG. 1. For example, the process 300 may be implemented by a memory system, which may be an example of the memory system 110 as described with reference to FIG. 1. The memory system may include a one or more memory devices, and one or more controllers of the one or more memory devices, which may be examples of the one or more memory devices 130, the memory system controller 115, and one or more local controllers 135 described with reference to FIG. 1. The process 300 may be an example of a process for the memory system to replace bad blocks with available user blocks, as described with reference to the block diagram 200 in FIG. 2.

Aspects of the process 300 may be implemented by one or more controllers (e.g., a memory system controller 115 or a local controller 135), among other components. Additionally, or alternatively, aspects of the process 300 may be implemented as instructions stored in one or more memories (e.g., firmware stored in one or more memories coupled with one or more memory devices). For example, the instructions, when executed by the one or more controllers (e.g., the memory system controller 115 or the local controller 135), may cause the one or more controllers (or a device or a system) to perform the operations of the process 300.

At 305, one or more access operations may be performed. For example, a controller of the first memory device (e.g., the memory system controller 115 or the local controller 135) may perform one or more read commands, write commands, erase commands, refresh commands, and the like. In some examples, a bad block may be generated while the memory system controller performs the one or more access commands. In other examples, a bad block may have been previously generated at the first memory device.

At 310, a bad block may be detected. For example, the memory system controller (e.g., or the local controller of the first memory device) may detect the bad block in response to an error in completing the one or more access operations (e.g., the bad block may cause the one or more access operations to fail). Additionally, or alternatively, the memory system controller may detect the bad block using ECC. For example, the memory system controller may detect the bad block in response to detecting an uncorrectable error (e.g., indicating the block may not reliably store data).

At 315, an available replacement block count may be decremented. In some examples, the available replacement block count (e.g., the quantity of available replacement blocks 235) may be decremented in response to the memory system controller detecting the bad block. The available replacement block count may initially be the total quantity of replacement blocks available to use to replace bad blocks in the first memory device, and the memory system controller may decrement the available replacement block count for each bad block detected. Additionally, or alternatively, at 315, an unavailable replacement block count may be incremented. In some examples, the unavailable block count (e.g., the quantity of unavailable replacement blocks 230) may be incremented in response to the memory system controller detecting the bad block. The unavailable replacement block count may initially be zero, and the memory system controller may increment the unavailable replacement block count for each bad block detected (e.g., for each time an available replacement block replaces a bad block).

In response to detecting the bad block (e.g., and decrementing the available replacement block count), the memory system controller may determine whether the quantity of replacement blocks of the first memory device satisfies the threshold value. For example, the memory system controller may compare a value of the available replacement block count, or a value of the unavailable replacement block count, to the threshold value. In some examples (e.g., if the memory system controller decrements the available replacement block count), the threshold value may be zero or a quantity of replacement blocks less than the total replacement block count (e.g., a quantity of available replacement blocks near zero). In other examples, (e.g., if the memory system controller increments the unavailable replacement block count), the threshold value may be the total quantity of replacement blocks.

At 320, the quantity of replacement blocks of the first memory device may be determined to not satisfy the threshold value. In some examples, the determination may be made in response to decrementing the value of the counter. For example, if the available replacement block count is greater than the threshold value, the memory system controller may replace the bad block with an available replacement block in response to determining that the quantity of replacement blocks of the first memory device does not satisfy the threshold value (e.g., as described with reference to the first replacement operation 240 in FIG. 2). Additionally, or alternatively, if the unavailable replacement block count is less than the threshold value, the memory system controller may replace the bad block with an available replacement block in response to determining that the quantity of unavailable replacement blocks does not satisfy the threshold value.

In response to replacing the bad block with the available replacement block, the memory system controller may continue to perform the one or more access commands. The memory system controller may continue performing the one or more access commands until detecting a second bad block, in which case, the memory system controller may decrement the available replacement block count, or increment the unavailable replacement block count, and compare the available replacement block count, or the unavailable replacement block count, to the threshold value.

At 325, an indication that the quantity of available replacement blocks satisfies the threshold value may be transmitted. In some examples, the transmission may occur in response to determining that the quantity of replacement blocks satisfies (e.g., is less than, or equal to) the threshold value. For example, if the replacement block count is less than, or equal to, the threshold value, the memory system controller may notify an end-user of the memory system. In some examples, the memory system controller may output a notification to the end-user (e.g., via a graphical user interface (GUI)) indicating the available replacement block count is less than or equal to the threshold value. Additionally, or alternatively, the indication may notify the end-user that the memory system controller may not successfully initiate a boot-up sequence, and the end-user may not access user data if the memory system controller does not replace the bad block (e.g., the first memory system may enter the write-protect mode).

At 330, the end-user may indicate whether the first memory device should replace the bad block with an available user block (e.g., an available user block 220). For example, the memory system controller may receive the indication via a GUI. In some examples, the memory system controller may receive the indication in response to a setting of the memory system set by the end-user (e.g., a default setting to save user data). At 335, the memory system controller may enter into the write-protect mode in response to receiving an indication not to replace the bad block with an available user block. As described further with reference to FIG. 2, the write-protect mode may not support any access operations that modify user data in the user blocks.

At 340, an indication to replace the bad block with an available user block of the first memory device may be received. In some examples, the indication may be received in response to transmitting the indication that the quantity of available replacement blocks satisfies the threshold value. For example, if the end-user indicates the memory system controller to replace the bad block, the memory system controller may replace the bad block with the available user block in response to receiving the indication, as described further with reference to the second replacement operation 245 in FIG. 2.

At 345, user data may be exported to a second memory device. In some examples, the user data may be exported to the second memory device from one or more user blocks of the first memory device in response to replacing the bad block with the available user block. For example, the end-user may export user data, via the memory system controller, to the second memory device. In some examples, the second memory device may be a memory device external to the memory system (e.g., an external computer, SSD, or other data storage device). Exporting the user data to the second memory device may result in previously unavailable user blocks to become available user blocks. In some examples, more available user blocks may enable the memory system controller to initiate the boot-up sequence and not enter the write-protect mode.

At 350, the memory system may reboot. In some examples, the memory system may reboot in response to exporting the user data from the first memory device to the second memory device. For example, the memory system controller may initiate the boot-up sequence. In some examples, rebooting (e.g., initiating the boot-up sequence) may enable the memory system controller to update the tracked quantity of unavailable user blocks, available user blocks, and the quantity of user blocks used to replace bad blocks after exporting the user data to the second memory device.

At 355, user data may be received. In some examples, the user data may be received in response to rebooting, and the user data may be stored to one or more user blocks of the multiple user blocks of the first memory device. For example, the memory system controller may receive the user data (e.g., re-provision and re-download software) from the second memory device. In some examples, re-provisioning and re-downloading software may be part of the boot-up sequence, and the tracked quantity of unavailable user blocks, available user blocks, and the quantity of user blocks used to replace bad blocks may affect the provisioning of data and software in the memory system.

At 360, the memory system may complete the boot-up sequence (e.g., transition from a relatively low power state to a higher power state). In some examples, the memory system controller may track the quantity of user blocks used to replace the bad blocks and indicate a quantity of available user blocks to the end-user. For example, the first memory device may include a first quantity of user blocks prior to rebooting and a second quantity of user blocks after rebooting, where the second quantity is less than the first quantity. In some examples, in response to successfully booting-up, the memory system controller may continue to perform one or more access operations, and the process 300 may restart at 305. Thus, the memory system may preserve user data (e.g., via exporting the data) and maintain its operational status (e.g., refrain from entering the write-protect mode) in response to replacing bad blocks with the one or more available user blocks, which may improve its overall performance and usable life.

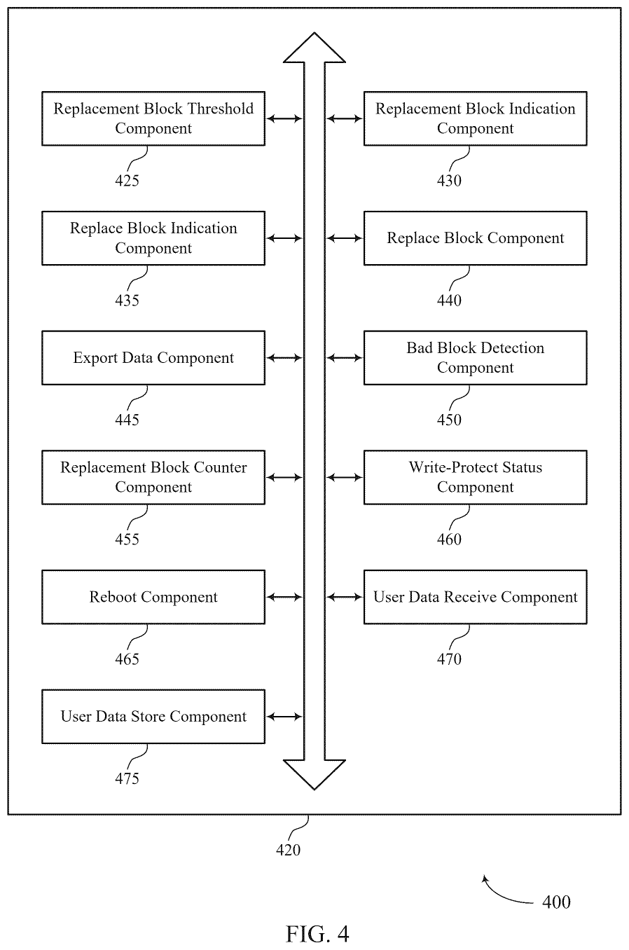

FIG. 4 shows a block diagram 400 of a memory system 420 that supports bad block replacement by a memory system in accordance with examples as disclosed herein. The memory system 420 may be an example of aspects of a memory system as described with reference to FIGS. 1 through 3. The memory system, which may be referred to herein as a storage system, may include one or more non-volatile memory cells (e.g., NAND memory cells). The memory system 420, or various components thereof, may be an example of means for performing various aspects of bad block replacement by a memory system as described herein. For example, the memory system 420 may include a replacement block threshold component 425, a replacement block indication component 430, a replace block indication component 435, a replace block component 440, an export data component 445, a bad block detection component 450, a replacement block counter component 455, a write-protect status component 460, a reboot component 465, a user data receive component 470, a user data store component 475, or any combination thereof. Each of these components, or components of subcomponents thereof (e.g., one or more processors, one or more memories), may communicate, directly or indirectly, with one another (e.g., via one or more buses).

The replacement block threshold component 425 may be configured as or otherwise support a means for determining whether a quantity of replacement blocks of a first memory device satisfies a threshold value in response to detecting a bad block including one or more errors. The replacement block indication component 430 may be configured as or otherwise support a means for transmitting an indication that the quantity of available replacement blocks satisfies the threshold value in response to determining that the quantity of replacement blocks satisfies the threshold value. The replace block indication component 435 may be configured as or otherwise support a means for receiving an indication to replace the bad block with an available user block of the first memory device in response to transmitting the indication that the quantity of available replacement blocks satisfies the threshold value, where the memory system includes a plurality of user blocks for storing user data. The replace block component 440 may be configured as or otherwise support a means for replacing the bad block with the available user block in response to receiving the indication to replace the bad block with the available user block.

In some examples, the export data component 445 may be configured as or otherwise support a means for exporting, to a second memory device, user data from one or more user blocks of the first memory device in response to replacing the bad block with the available user block.

In some examples, the reboot component 465 may be configured as or otherwise support a means for rebooting, by the memory system, in response to exporting the user data from the first memory device to the second memory device.

In some examples, the user data receive component 470 may be configured as or otherwise support a means for receiving, at the first memory device from the second memory device, the user data in response to rebooting. In some examples, the user data store component 475 may be configured as or otherwise support a means for storing the user data to one or more user blocks of the plurality of user blocks of the first memory device. In some examples, the first memory device is associated with a first quantity of user blocks prior to rebooting and a second quantity of user blocks after rebooting. In some examples, the second quantity is less than the first quantity.

In some examples, to support determining whether the quantity of replacement blocks of the first memory device satisfies the threshold value, the replacement block threshold component 425 may be configured as or otherwise support a means for comparing a value of a counter to a threshold value.

In some examples, the bad block detection component 450 may be configured as or otherwise support a means for detecting the bad block. In some examples, the replacement block counter component 455 may be configured as or otherwise support a means for incrementing the value of the counter in response to detecting the bad block.

In some examples, the bad block detection component 450 may be configured as or otherwise support a means for detecting a second bad block of the first memory device before detecting the bad block. In some examples, the replacement block counter component 455 may be configured as or otherwise support a means for incrementing a value of a counter in response to detecting the second bad block. In some examples, the replacement block threshold component 425 may be configured as or otherwise support a means for determining that the quantity of replacement blocks of the first memory device does not satisfy the threshold value in response to incrementing the value of the counter. In some examples, the replace block component 440 may be configured as or otherwise support a means for replacing the second bad block with a replacement block in response to determining that the quantity of replacement blocks of the first memory device does not satisfy the threshold value.

In some examples, the replacement block threshold component 425 may be configured as or otherwise support a means for determining whether the quantity of replacement blocks of the first memory device satisfies the threshold value in response to detecting a third bad block. In some examples, the replacement block indication component 430 may be configured as or otherwise support a means for transmitting a second indication that the quantity of available replacement blocks satisfies the threshold value in response to determining that the quantity of replacement blocks satisfies the threshold value. In some examples, the replace block indication component 435 may be configured as or otherwise support a means for receiving a second indication not to replace the third bad block with an available user block of the first memory device in response to transmitting the second indication that the quantity of available replacement blocks satisfies the threshold value. In some examples, the write-protect status component 460 may be configured as or otherwise support a means for entering, by the memory system, into a write protect mode in response to receiving the second indication not to replace the third bad block with an available user block of the first memory device. In some examples, the replacement blocks are designated for replacing bad blocks of the first memory device.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

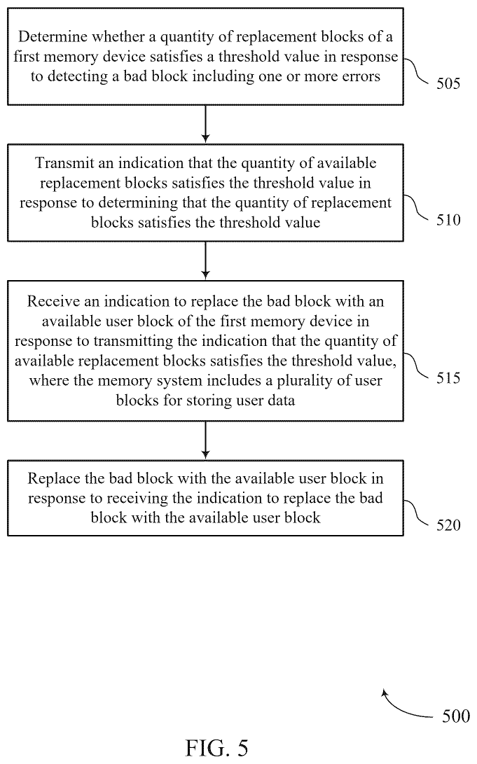

FIG. 5 shows a flowchart illustrating a method 500 that supports bad block replacement by a memory system in accordance with examples as disclosed herein. The operations of method 500 may be implemented by a memory system or its components as described herein. For example, the operations of method 500 may be performed by a memory system as described with reference to FIGS. 1 through 4. The memory system, which may be referred to herein as a storage system, may include one or more non-volatile memory cells (e.g., NAND memory cells). In some examples, a memory system may execute a set of instructions to control the functional elements of the device to perform the described functions. Additionally, or alternatively, the memory system may perform aspects of the described functions using special-purpose hardware.

At 505, the method may include determining whether a quantity of replacement blocks of a first memory device satisfies a threshold value in response to detecting a bad block including one or more errors. In some examples, aspects of the operations of 505 may be performed by a replacement block threshold component 425 as described with reference to FIG. 4.

At 510, the method may include transmitting an indication that the quantity of available replacement blocks satisfies the threshold value in response to determining that the quantity of replacement blocks satisfies the threshold value. In some examples, aspects of the operations of 510 may be performed by a replacement block indication component 430 as described with reference to FIG. 4.

At 515, the method may include receiving an indication to replace the bad block with an available user block of the first memory device in response to transmitting the indication that the quantity of available replacement blocks satisfies the threshold value, where the memory system includes a plurality of user blocks for storing user data. In some examples, aspects of the operations of 515 may be performed by a replace block indication component 435 as described with reference to FIG. 4.

At 520, the method may include replacing the bad block with the available user block in response to receiving the indication to replace the bad block with the available user block. In some examples, aspects of the operations of 520 may be performed by a replace block component 440 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for determining whether a quantity of replacement blocks of a first memory device satisfies a threshold value in response to detecting a bad block including one or more errors; transmitting an indication that the quantity of available replacement blocks satisfies the threshold value in response to determining that the quantity of replacement blocks satisfies the threshold value; receiving an indication to replace the bad block with an available user block of the first memory device in response to transmitting the indication that the quantity of available replacement blocks satisfies the threshold value, where the memory system includes a plurality of user blocks for storing user data; and replacing the bad block with the available user block in response to receiving the indication to replace the bad block with the available user block.

Aspect 2: The method, apparatus, or non-transitory computer-readable medium of aspect 1, further including operations, features, circuitry, logic, means, or instructions, or any combination thereof for exporting, to a second memory device, user data from one or more user blocks of the first memory device in response to replacing the bad block with the available user block.

Aspect 3: The method, apparatus, or non-transitory computer-readable medium of aspect 2, further including operations, features, circuitry, logic, means, or instructions, or any combination thereof for rebooting, by the memory system, in response to exporting the user data from the first memory device to the second memory device.

Aspect 4: The method, apparatus, or non-transitory computer-readable medium of aspect 3, further including operations, features, circuitry, logic, means, or instructions, or any combination thereof for receiving, at the first memory device from the second memory device, the user data in response to rebooting and storing the user data to one or more user blocks of the plurality of user blocks of the first memory device.

Aspect 5: The method, apparatus, or non-transitory computer-readable medium of any of aspects 3 through 4, where the first memory device is associated with a first quantity of user blocks prior to rebooting and a second quantity of user blocks after rebooting and the second quantity is less than the first quantity.

Aspect 6: The method, apparatus, or non-transitory computer-readable medium of any of aspects 1 through 5, where determining whether the quantity of replacement blocks of the first memory device satisfies the threshold value includes operations, features, circuitry, logic, means, or instructions, or any combination thereof for comparing a value of a counter to a threshold value.

Aspect 7: The method, apparatus, or non-transitory computer-readable medium of aspect 6, further including operations, features, circuitry, logic, means, or instructions, or any combination thereof for detecting the bad block and incrementing the value of the counter in response to detecting the bad block.

Aspect 8: The method, apparatus, or non-transitory computer-readable medium of any of aspects 1 through 7, further including operations, features, circuitry, logic, means, or instructions, or any combination thereof for detecting a second bad block of the first memory device before detecting the bad block; incrementing a value of a counter in response to detecting the second bad block; determining that the quantity of replacement blocks of the first memory device does not satisfy the threshold value in response to incrementing the value of the counter; and replacing the second bad block with a replacement block in response to determining that the quantity of replacement blocks of the first memory device does not satisfy the threshold value.

Aspect 9: The method, apparatus, or non-transitory computer-readable medium of any of aspects 1 through 8, further including operations, features, circuitry, logic, means, or instructions, or any combination thereof for determining whether the quantity of replacement blocks of the first memory device satisfies the threshold value in response to detecting a third bad block; transmitting a second indication that the quantity of available replacement blocks satisfies the threshold value in response to determining that the quantity of replacement blocks satisfies the threshold value; receiving a second indication not to replace the third bad block with an available user block of the first memory device in response to transmitting the second indication that the quantity of available replacement blocks satisfies the threshold value; and entering, by the memory system, into a write protect mode in response to receiving the second indication not to replace the third bad block with an available user block of the first memory device.

Aspect 10: The method, apparatus, or non-transitory computer-readable medium of any of aspects 1 through 9, where the replacement blocks are designated for replacing bad blocks of the first memory device.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
determine whether a quantity of replacement blocks of a first memory device satisfies a threshold value in response to detecting a bad block comprising one or more errors;
transmit an indication that the quantity of available replacement blocks satisfies the threshold value in response to determining that the quantity of replacement blocks satisfies the threshold value;
receive an indication to replace the bad block with an available user block of the first memory device in response to transmitting the indication that the quantity of available replacement blocks satisfies the threshold value, wherein the memory system comprises a plurality of user blocks for storing user data; and
replace the bad block with the available user block in response to receiving the indication to replace the bad block with the available user block.

2. The memory system of claim 1, wherein the processing circuitry is further configured to cause the memory system to:
export, to a second memory device, user data from one or more user blocks of the first memory device in response to replacing the bad block with the available user block.

3. The memory system of claim 2, wherein the processing circuitry is further configured to cause the memory system to:
reboot the memory system in response to exporting the user data from the first memory device to the second memory device.

4. The memory system of claim 3, wherein the processing circuitry is further configured to cause the memory system to:
receive, at the first memory device from the second memory device, the user data in response to rebooting; and
store the user data to one or more user blocks of the plurality of user blocks of the first memory device.

5. The memory system of claim 3, wherein the first memory device is associated with a first quantity of user blocks prior to rebooting and a second quantity of user blocks after rebooting, and wherein the second quantity is less than the first quantity.

6. The memory system of claim 1, wherein to determine whether the quantity of replacement blocks of the first memory device satisfies the threshold value, the processing circuitry is configured to cause the memory system to:
compare a value of a counter to a threshold value.

7. The memory system of claim 6, wherein the processing circuitry is further configured to cause the memory system to:
detect the bad block; and
increment the value of the counter in response to detecting the bad block.

8. The memory system of claim 1, wherein the processing circuitry is further configured to cause the memory system to:
detect a second bad block of the first memory device before detecting the bad block;
increment a value of a counter in response to detecting the second bad block;
determine that the quantity of replacement blocks of the first memory device does not satisfy the threshold value in response to incrementing the value of the counter; and
replace the second bad block with a replacement block in response to determining that the quantity of replacement blocks of the first memory device does not satisfy the threshold value.

9. The memory system of claim 1, wherein the processing circuitry is further configured to cause the memory system to:
determine whether the quantity of replacement blocks of the first memory device satisfies the threshold value in response to detecting a third bad block;
transmit a second indication that the quantity of available replacement blocks satisfies the threshold value in response to determining that the quantity of replacement blocks satisfies the threshold value;
receive a second indication not to replace the third bad block with an available user block of the first memory device in response to transmitting the second indication that the quantity of available replacement blocks satisfies the threshold value; and
enter, by the memory system, into a write protect mode in response to receiving the second indication not to replace the third bad block with an available user block of the first memory device.

10. The memory system of claim 1, wherein the replacement blocks are designated for replacing bad blocks of the first memory device.

11. A non-transitory computer-readable medium storing code comprising instructions which, when executed by one or more processors of a memory system, cause the memory system to:
determine whether a quantity of replacement blocks of a first memory device satisfies a threshold value in response to detecting a bad block comprising one or more errors;
transmit an indication that the quantity of available replacement blocks satisfies the threshold value in response to determining that the quantity of replacement blocks satisfies the threshold value;
receive an indication to replace the bad block with an available user block of the first memory device in response to transmitting the indication that the quantity of available replacement blocks satisfies the threshold value, wherein the memory system comprises a plurality of user blocks for storing user data; and
replace the bad block with the available user block in response to receiving the indication to replace the bad block with the available user block.

12. The non-transitory computer-readable medium of claim 11, wherein the instructions, when executed by the one or more processors of the memory system, further cause the memory system to:
export, to a second memory device, user data from one or more user blocks of the first memory device in response to replacing the bad block with the available user block.

13. The non-transitory computer-readable medium of claim 12, wherein the instructions, when executed by the one or more processors of the memory system, further cause the memory system to:
reboot the memory system in response to exporting the user data from the first memory device to the second memory device.

14. The non-transitory computer-readable medium of claim 13, wherein the instructions, when executed by the one or more processors of the memory system, further cause the memory system to:
receive, at the first memory device from the second memory device, the user data in response to rebooting; and
store the user data to one or more user blocks of the plurality of user blocks of the first memory device.

15. The non-transitory computer-readable medium of claim 13, wherein the first memory device is associated with a first quantity of user blocks prior to rebooting and a second quantity of user blocks after rebooting, and wherein the second quantity is less than the first quantity.

16. The non-transitory computer-readable medium of claim 11, wherein the instructions to determine whether the quantity of replacement blocks of the first memory device satisfies the threshold value, when executed by the one or more processors of the memory system, further cause the memory system to:
compare a value of a counter to a threshold value.

17. The non-transitory computer-readable medium of claim 16, wherein the instructions, when executed by the one or more processors of the memory system, further cause the memory system to:
detect the bad block; and
increment the value of the counter in response to detecting the bad block.

18. The non-transitory computer-readable medium of claim 11, wherein the instructions, when executed by the one or more processors of the memory system, further cause the memory system to:
detect a second bad block of the first memory device before detecting the bad block;
increment a value of a counter in response to detecting the second bad block;
determine that the quantity of replacement blocks of the first memory device does not satisfy the threshold value in response to incrementing the value of the counter; and
replace the second bad block with a replacement block in response to determining that the quantity of replacement blocks of the first memory device does not satisfy the threshold value.

19. The non-transitory computer-readable medium of claim 11, wherein the instructions, when executed by the one or more processors of the memory system, further cause the memory system to:
determine whether the quantity of replacement blocks of the first memory device satisfies the threshold value in response to detecting a third bad block;
transmit a second indication that the quantity of available replacement blocks satisfies the threshold value in response to determining that the quantity of replacement blocks satisfies the threshold value;
receive a second indication not to replace the third bad block with an available user block of the first memory device in response to transmitting the second indication that the quantity of available replacement blocks satisfies the threshold value; and
enter, by the memory system, into a write protect mode in response to receiving the second indication not to replace the third bad block with an available user block of the first memory device.

20. The non-transitory computer-readable medium of claim 11, wherein the replacement blocks are designated for replacing bad blocks of the first memory device.

21. A method by a memory system, comprising:
determining whether a quantity of replacement blocks of a first memory device satisfies a threshold value in response to detecting a bad block comprising one or more errors;
transmitting an indication that the quantity of available replacement blocks satisfies the threshold value in response to determining that the quantity of replacement blocks satisfies the threshold value;
receiving an indication to replace the bad block with an available user block of the first memory device in response to transmitting the indication that the quantity of available replacement blocks satisfies the threshold value, wherein the memory system comprises a plurality of user blocks for storing user data; and
replacing the bad block with the available user block in response to receiving the indication to replace the bad block with the available user block.

22. The method of claim 21, further comprising:
exporting, to a second memory device, user data from one or more user blocks of the first memory device in response to replacing the bad block with the available user block.

23. The method of claim 21, wherein determining whether the quantity of replacement blocks of the first memory device satisfies the threshold value comprises:
comparing a value of a counter to a threshold value.

24. The method of claim 21, further comprising:
detecting a second bad block of the first memory device before detecting the bad block;
incrementing a value of a counter in response to detecting the second bad block;
determining that the quantity of replacement blocks of the first memory device does not satisfy the threshold value in response to incrementing the value of the counter; and
replacing the second bad block with a replacement block in response to determining that the quantity of replacement blocks of the first memory device does not satisfy the threshold value.

25. The method of claim 21, further comprising:
determining whether the quantity of replacement blocks of the first memory device satisfies the threshold value in response to detecting a third bad block;
transmitting a second indication that the quantity of available replacement blocks satisfies the threshold value in response to determining that the quantity of replacement blocks satisfies the threshold value;
receiving a second indication not to replace the third bad block with an available user block of the first memory device in response to transmitting the second indication that the quantity of available replacement blocks satisfies the threshold value; and
entering, by the memory system, into a write protect mode in response to receiving the second indication not to replace the third bad block with an available user block of the first memory device.
